(19) United States
(12) Patent Application Publication
(10) Pub. No.: US 2015/0036332 A1
(43) Pub. Date: Feb. 5, 2015

(54) DISPLAY ILLUMINATING MODULE

(71) Applicant: DELTA ELECTRONICS, INC., Taoyuan Hsien (TW)

(72) Inventors: Bor WANG, Taoyuan Hsien (TW); Ming-Yo HSU, Taoyuan Hsien (TW)

(73) Assignee: DELTA ELECTRONICS, INC., Taoyuan Hsien (TW)

(21) Appl. No.: 14/049,512

(22) Filed: Oct. 9, 2013

(30) Foreign Application Priority Data
Jul. 30, 2013 (TW) 102127195

(51) Int. Cl. F21V 13/14

(52) U.S. Cl. CPC F21V 13/14
USPC 362/231

(57) ABSTRACT

A display illuminating module includes a light source, a rotating wheel, an actuator, a wavelength conversion wheel, and an optical module. The light source is configured for providing a first light beam with a first wavelength. The rotational wheel includes a transmission segment and a reflective segment. The actuator is configured for disposing the transmission segment and the reflective segment on the propagation path of the first light beam in sequence. The wavelength conversion wheel includes a first wavelength conversion segment configured for converting the first light beam into a second light beam with a second wavelength. The optical module is configured for guiding the first light beam transmitted from the transmission segment to the wavelength conversion wheel, guiding the first light beam reflected from the reflective segment to a desired position, and guiding the second light beam propagated from the first wavelength conversion segment to the desired position.

### RELATED APPLICATIONS

This application claims priority to Taiwan Application Serial Number 102127195, filed Jul. 30, 2013, which is herein incorporated by reference.

### BACKGROUND

1. Technical Field

The present disclosure relates to a display illuminating module.

2. Description of Related Art

In recent years, slim and compact projection devices have been becoming mainstream in the market because of the improvement on the manufacturing technology of the projection devices. As such, a display illuminating module as light source of the projection device also needs to be small-sized along with the size reduction of the projection device. However, as the display illuminating module being downsized, it can accommodate less and less elements. Therefore, many in the industry are striving to keep high efficiency and low energy consumption output for the display illuminating module under the limited number of the elements.

### SUMMARY

An aspect of the present invention provides a display illuminating module including a light source, a rotational wheel, an actuator, a wavelength conversion wheel, and an optical module. The light source is configured for providing a first light beam with a first wavelength. The rotational wheel includes a transmission segment and a reflective segment. The actuator is connected to the rotational wheel and is configured for rotating the rotational wheel to dispose the transmission segment and the reflective segment on a propagation path of the first light beam in sequence. The wavelength conversion wheel includes a first wavelength conversion segment configured for converting the first light beam into a second light beam with a second wavelength. The optical module is configured for guiding the first light beam transmitted from the transmission segment of the rotational wheel to the wavelength conversion wheel, guiding the first light beam reflected from the reflective segment of the rotational wheel to a desired position, and guiding the second light beam propagating from the first wavelength conversion segment of the wavelength conversion wheel to the desired position.

In one or more embodiments, the wavelength conversion wheel further includes a second wavelength conversion segment configured for converting the first light beam into a third light beam with a third wavelength. The actuator is further connected to the wavelength conversion wheel, and the actuator is further configured for rotating the wavelength conversion wheel to dispose the first wavelength conversion segment and the second wavelength conversion segment on the propagation path of the first light beam passing through the rotational wheel in sequence. The optical module is further configured for guiding the third light beam propagating from the second wavelength conversion segment of the wavelength conversion wheel to the desired position.

In one or more embodiments, the first wavelength conversion segment and the second wavelength conversion segment are arc-shaped, and an arc length of the first wavelength conversion segment is different from an arc length of the second wavelength conversion segment.

In one or more embodiments, the reflective segment and the transmission segment of the rotational wheel are arc-shaped, and an arc length of the reflective segment is different from an arc length of the transmission segment.

In one or more embodiments, the optical module includes a first dichroic mirror, a reflective mirror, and a second dichroic mirror. The first dichroic mirror allows the first light beam to pass therethrough and is configured for reflecting the second light beam to the second dichroic mirror. The reflective mirror is configured for reflecting the first light beam reflected from the rotational wheel to the second dichroic mirror. The second dichroic mirror allows the second light beam to pass therethrough and is configured for reflecting the first light beam propagating from the reflective mirror to the desired position.

In one or more embodiments, the optical module includes a first dichroic mirror, a reflective mirror, and a second dichroic mirror. The first dichroic mirror allows the second light beam to pass therethrough and is configured for reflecting the first light beam propagating from the rotational wheel to the wavelength conversion wheel. The reflective mirror is configured for reflecting the first light beam reflected from the rotational wheel to the second dichroic mirror. The second dichroic mirror allows the first light beam to pass therethrough and is configured for reflecting the second light beam to the desired position.

In one or more embodiments, the optical module includes a reflective mirror, a first dichroic mirror, and a second dichroic mirror. The reflective mirror is configured for reflecting the first light beam reflected from the rotational wheel to the first dichroic mirror. The first dichroic mirror allows the second light beam to pass therethrough and is configured for reflecting the first light beam propagating from the reflective mirror to the wavelength conversion wheel. The second dichroic mirror allows the first light beam to pass therethrough and is configured for reflecting the second light beam to the desired position.

In one or more embodiments, the optical module includes a first dichroic mirror, a reflective mirror, and a second dichroic mirror. The first dichroic mirror allows the first light beam to pass therethrough and is configured for reflecting the second light beam to the reflective mirror. The reflective mirror is configured for reflecting the second light beam propagating from the first dichroic mirror to the second dichroic mirror. The second dichroic mirror allows the first light beam to pass therethrough and is configured for reflecting the second light beam to the desired position.

In one or more embodiments, the display illuminating module further includes a plurality of lenses respectively disposed between the light source and the rotational wheel, between the optical module and the wavelength conversion wheel, and on the propagation path of the first light beam passing through the rotational wheel.

### BRIEF DESCRIPTION OF THE DRAWINGS

FIG. 1A is a schematic diagram of a display illuminating module in a first time period according to one embodiment of the present invention;

FIG. 1B is a schematic diagram of the display illuminating module of FIG. 1A in other time periods;

FIG. 2 is a front view of a rotational wheel of FIG. 1A;

FIG. 3 is a front view of a wavelength conversion wheel of FIG. 1A;

FIG. 4 is a schematic diagram of the display illuminating module according to another embodiment of the present invention;

FIG. 5 is a schematic diagram of the display illuminating module according to yet another embodiment of the present invention; and

FIG. 6 is a schematic diagram of the display illuminating module according to yet another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically depicted in order to simplify the drawings.

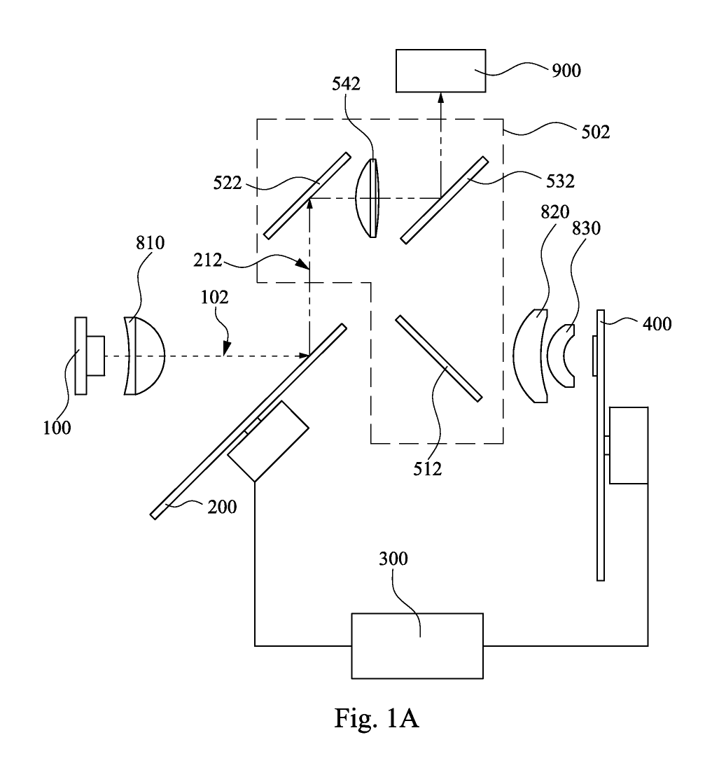

FIG. 1A is a schematic diagram of a display illuminating module in a first time period according to one embodiment of the present invention. FIG. 1B is a schematic diagram of the display illuminating module of FIG. 1A in other time periods. Reference is made to FIG. 1A first. The display illuminating module includes a light source 100, a rotational wheel 200, an actuator 300, a wavelength conversion wheel 400, and an optical module 502. The light source 100 is configured for providing a first light beam with a first wavelength. For example, in this embodiment, the first light beam can be a blue light beam. In the first time period, the blue light beam emitted from the light source 100 impinges on the rotational wheel 200 along a path 102, and is reflected to the optical module 502 by the rotational wheel 200. The blue light beam is guided to a desired position 900 along a path 212 by the optical module 502, where a light tunnel or a light modulator can be disposed on the desired position 900. However, the scope of the claimed invention should not be limited in this respect.

Reference is made to FIG. 1B. In the second time period, the blue light beam impinges on the rotational wheel 200 along the path 102. After passing through the rotational wheel 200, the blue light is incident to the optical module 502, and is guided to the wavelength conversion wheel 400 along a path 222 by the optical module 502. The wavelength conversion wheel 400 is configured for converting the blue light into a second light beam with a second wavelength, where the second light beam can be a green light beam. The green light beam is then incident to the optical module 502, and is guided to the desired position 900 along a path 402 by the optical module 502. Consequently, light beams with different wavelengths are obtained in sequence using the display illuminating module in this embodiment. It should be noticed the dashed lines in FIG. 1A and FIG. 1B represent the propagation paths of the light beams.

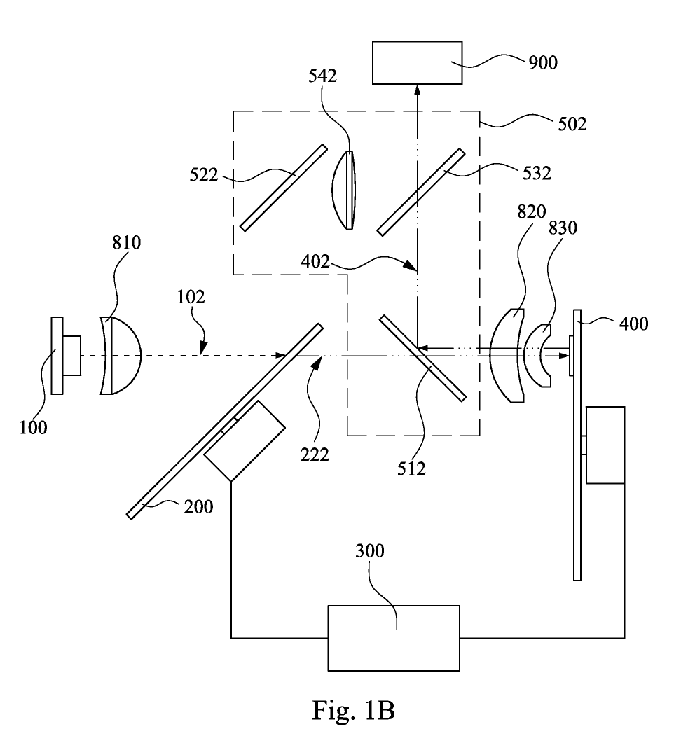

FIG. 2 is a front view of the rotational wheel 200 of FIG. 1A. In greater detail, the rotational wheel 200 includes a reflective segment 210 and a transmission segment 220. The actuator 300 (see FIG. 1A) is connected to the rotational wheel 200 and is configured for rotating the rotational wheel 200, such that the reflective segment 210 and the transmission segment 220 are respectively disposed on the propagation path of the blue light beam in the first time period and in the second time period. Therefore, the blue light beam is reflected by the reflective segment 210 of the rotational wheel 200 in the first time period, and the blue light beam passes through the transmission segment 220 of the rotational wheel 200 in the second time period.

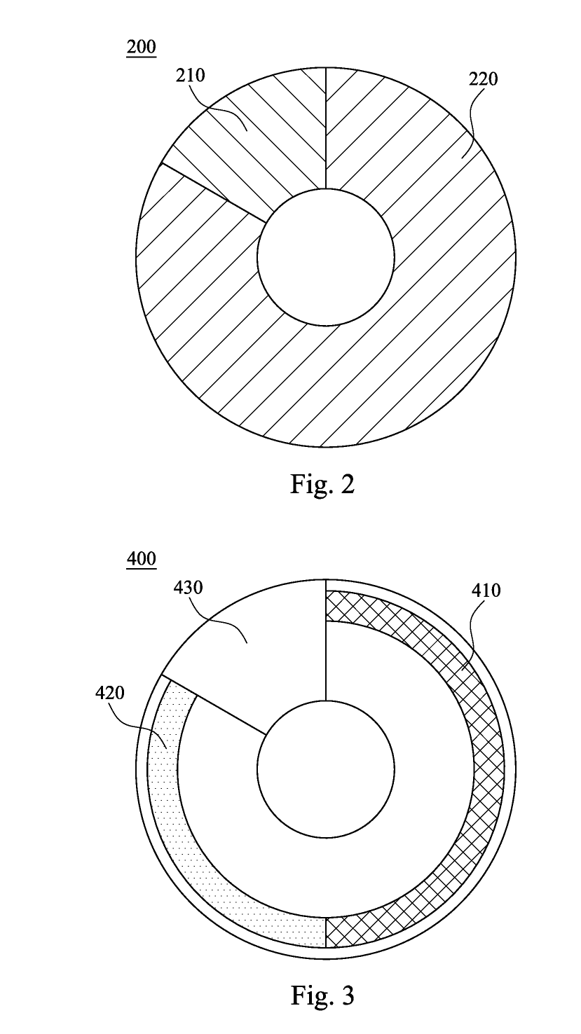

FIG. 3 is a front view of the wavelength conversion wheel 400 of FIG. 1A. The wavelength conversion wheel 400 includes a first wavelength conversion segment which can be a green conversion segment 410. The green conversion segment 410 is configured for converting the blue light beam into a green light beam with green light wavelength. In the second time period, the green conversion segment 410 can be disposed on the path 222 (see FIG. 1B) in the second time period, such that the blue light beam can impinge on the green conversion segment 410 and is converted into the green light beam. The green conversion segment 410 can include green phosphor. However, the scope of the claimed invention should not be limited in this respect.

In this embodiment, the wavelength conversion wheel 400 can further include a second wavelength conversion segment which can be a red conversion segment 420. The red conversion segment 420 is configured for converting the blue light beam into a red light beam with red light wavelength. Therefore, the display illuminating module in this embodiment can provide red, green, and blue primary-color light beams in sequence. The red conversion segment 420 can include red phosphor. However, the scope of the claimed invention should not be limited in this respect.

Reference is made to FIG. 1B. In greater detail, the actuator 300 can further be connected to the wavelength conversion wheel 400, and is further configured for rotating the wavelength conversion wheel 400 to dispose the green conversion segment 410 and the red conversion segment 420 on the propagation path of the blue light beam passing through the rotational wheel 200 (i.e. the path 222) in sequence. Therefore, the blue light beam can pass through the rotational wheel 200 to the green conversion segment 410 in the second time period. In a third time period, the blue light beam passes through the rotational wheel 200 to the red conversion segment 420, such that the blue light beam is converted into the red light beam. The red light beam is then incident to the optical module 502, and is guided to the desired position 900 along the path 402 by the optical module 502.

Reference is made back to FIG. 3. Moreover, since the blue light beam does not propagate to the wavelength conversion wheel 400 in the first time period, an area 430 of the wavelength conversion wheel 400 without wavelength converting function can be disposed on the path 222 (see FIG. 1B) in the first time period to reduce the cost of the wavelength conversion wheel 400. However, the scope of the claimed invention should not be limited in this respect.

Therefore, the display illuminating module can generate light beams with different wavelengths in sequence with the structure mentioned above. The following paragraphs provide detailed explanations with respect to how to obtain the light beams with different wavelengths.

Reference is made back to FIG. 1A. The optical module 502 includes a first dichroic mirror 512, a reflective mirror 522, and a second dichroic mirror 532. The first dichroic mirror 512 allows the blue light beam to pass therethrough, and is configured for reflecting the green light beam and the red light beam to the second dichroic mirror 532. The reflective mirror 522 is configured for reflecting the blue light beam reflected from the rotational wheel 200 to the second dichroic mirror 532. The second dichroic mirror 532 allows the green light beam and the red light beam to pass therethrough, and is configured for reflecting the blue light beam propagating from the reflective mirror 522 to the desired position 900. The optical module 502 can further include a lens 542 disposed between the reflective mirror 522 and the second dichroic mirror 532. Moreover, the display illuminating module can further include a plurality of lenses 810, 820, and 830. The lens 810 is disposed between the light source 100 and the rotational wheel 200, and the lenses 820 and 830 are disposed between the optical module 502 and the wavelength conversion wheel 400. The lenses 810, 820, and 830 are all disposed on the propagation path of the blue light beam.

In the first time period, the actuator 300 simultaneously rotates the rotational wheel 200 to make the reflective segment 210 (see FIG. 2) of the rotational wheel 200 disposed on the propagation path of the blue light beam, and the wavelength conversion wheel 400 to make the area 430 (see FIG. 3) of the wavelength conversion wheel 400 disposed on the path 222 (see FIG. 1B). The blue light beam emitted from the light source 100 passes through the lens 810 and propagates to the rotational wheel 200 along the path 102. Being reflected to the optical module 502 by the reflective segment 210 of the rotational wheel 200, the blue light beam is guided to the desired position 900 along the path 212 by the optical module 502. The blue light beam first propagates to the reflective mirror 522 which reflects the blue light beam to the lens 542. After passing through the lens 542, the blue light beam is reflected to the desired position 900 by the second dichroic mirror 532.

Reference is made back to FIG. 1B. In the second time period, the actuator 300 simultaneously rotates the rotational wheel 200 to make the transmission segment 220 (see FIG. 2) of the rotational wheel 200 disposed on the propagation path of the blue light beam, and the wavelength conversion wheel 400 to make the green conversion segment 410 (see FIG. 3) of the wavelength conversion wheel 400 disposed on the path 222. The blue light beam emitted from the light source 100 passes through the lens 810 and propagates to the rotational wheel 200 along the path 102. The blue light beam then passes through the transmission segment 220 of the rotational wheel 220 and the first dichroic mirror 512 in sequence. Being converged by the lenses 820 and 830, the blue light beam propagates to the green conversion segment 410 of the wavelength conversion wheel 400. The green conversion segment 410 converts the blue light beam into the green light beam, which is reflected back to the lenses 820 and 830. The green light beam is guided to the desired position 900 along the path 402 by the optical module 502 after being converged by the lenses 820 and 830. The green light beam first propagates to the first dichroic mirror 512, which reflects the green light beam to the second dichroic mirror 532. Subsequently, the green light beam passes through the second dichroic mirror 532 and propagates to the desired position 900.

In the third time period, the actuator 300 simultaneously rotates the rotational wheel 200 to make the transmission segment 220 (see FIG. 2) of the rotational wheel 200 disposed on the propagation path of the blue light beam, and the wavelength conversion wheel 400 to make the red conversion segment 420 (see FIG. 3) of the wavelength conversion wheel 400 disposed on the path 222. The blue light beam emitted from the light source 100 passes through the lens 810 and propagates to the rotational wheel 200 along the path 102. The blue light beam propagates to the red conversion segment 420 of the wavelength conversion wheel 400 along the path 222. The red conversion segment 420 converts the blue light beam into the red light beam, which is reflected back to the lenses 820 and 830. The red light beam is guided to the desired position 900 along the path 402 by the optical module 502 after being converged by the lenses 820 and 830. The red light beam first propagates to the first dichroic mirror 512, which reflects the red light beam to the second dichroic mirror 532. Subsequently, the red light beam passes through the second dichroic mirror 532 and propagates to the desired position 900. Consequently, the display illuminating module can generate the blue light beam, the green light beam, and the red light beam in sequence as long as the actuator 300 rotates the rotational wheel 200 and the wavelength conversion wheel 400 in sequence using the method mentioned above.

In summary, the display illuminating module in the present embodiment can generate the blue light beam, the green light beam, and the red light beam in sequence by only one light source 100, and the optical module 502 can only include the first dichroic mirror 512, the reflective mirror 522, and the second dichroic mirror 532, such that the size and the cost of the display illuminating module can be both reduced.

It should be understood that although the actuator 300 can control the rotational wheel 200 and the wavelength conversion wheel 400 simultaneously, the rotational wheel 200 and the wavelength conversion wheel 400 can be connected to different actuators 300 in the other embodiments. In other words, two actuators 300 can respectively control the rotational wheel 200 and the wavelength conversion wheel 400. Moreover, although the display illuminating module includes lenses 810, 820, and 830, the scope of the claimed invention should not be limited in this respect. A person having ordinary skill in the art may select a proper number and position for the lenses according to actual requirements.

Reference is made to FIG. 3. The display illuminating module can control the white balance of its light through adjusting the intensities of light beams with different wavelengths. In particular, the intensity of light beam generated by the wavelength conversion wheel 400 is proportional to the length of its time period. In other words, the intensity of the light beam is higher if the time period is longer. Therefore, in one or more embodiments, the green conversion segment 410 and the red conversion segment 420 of the wavelength conversion wheel 400 can be arc-shaped, where the arc length of the green conversion segment 410 is different from the arc length of the red conversion segment 420. Taking FIG. 3 as an example, the arc length of the green conversion segment 410 is longer than that of the red conversion segment 420. As such, the length of the second time period is different from that of the third time period if the rotational rate of the wavelength conversion wheel 400 is constant, leading to different intensities of the green light beam and the red light beam.

Moreover, reference is made to FIG. 2. Similarly, the display illuminating module can control the white balance of its light through adjusting the reflective segment 210 and the transmission segment 220 of the rotational wheel 200. In particular, in one or more embodiments, the reflective segment 210 and the transmission segment 220 of the rotational wheel 200 can be arc-shaped, where the arc length of the reflective segment 210 is different from that of the transmission segment 220. Taking FIG. 2 as an example, the arc length of the reflective segment 210 is shorter than that of the transmission segment 220. In addition, the arc length of the transmission segment 220 can substantially be the same as the arc length summation of the green conversion segment 410 and the red conversion segment 420 (both see FIG. 3). In summary, the white balance of the display illuminating module can be adjusted by designing the arc length ratio of the reflective segment 210 to the transmission segment 220 of the rotational wheel 200, and/or the arc length ratio of the green conversion segment 410 to the red conversion segment 420 of the wavelength conversion wheel 400.

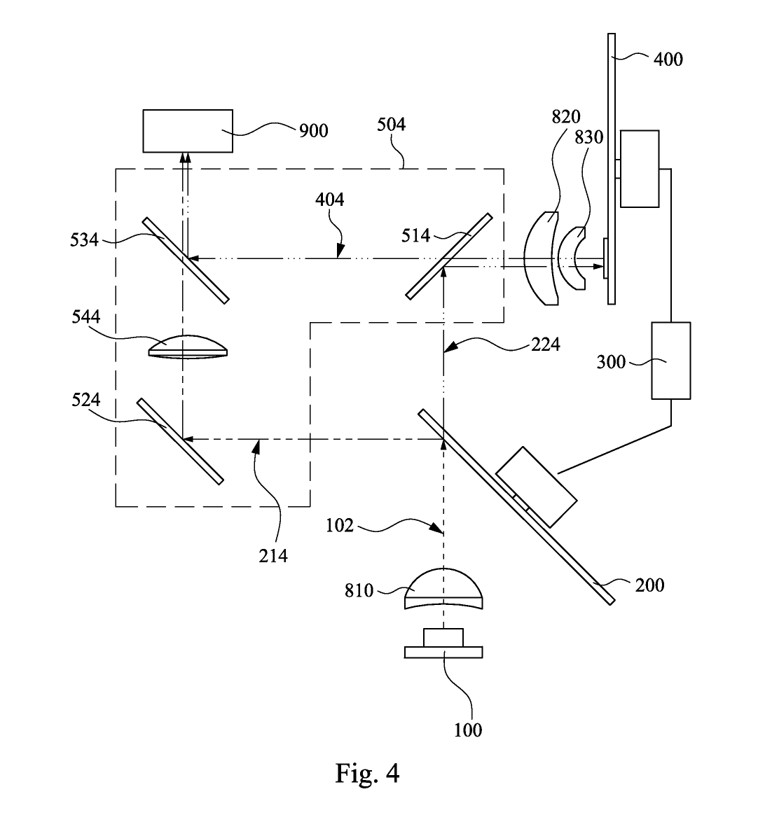

FIG. 4 is a schematic diagram of the display illuminating module according to another embodiment of the present invention. The difference between the display illuminating module of the present embodiment and the embodiment of FIG. 1A and FIG. 1B pertains to the elements of the optical module. In this embodiment, the optical module 504 includes a first dichroic mirror 514, a reflective mirror 524, and a second dichroic mirror 534. The first dichroic mirror 514 allows the green light beam and the red light beam to pass therethrough, and is configured for reflecting the blue light beam propagating from the rotational wheel 200 to the wavelength conversion wheel 400. The reflective mirror 524 is configured for reflecting the blue light beam reflected from the rotational wheel 200 to the second dichroic mirror 534. The second dichroic mirror 534 allows the blue light beam to pass therethrough, and is configured for reflecting the green light beam and the red light beam to the desired position 900. The optical module 504 can further include a lens 544 disposed between the reflective mirror 524 and the second dichroic mirror 534.

In the first time period, the actuator 300 simultaneously rotates the rotational wheel 200 to make the reflective segment 210 (see FIG. 2) of the rotational wheel 200 disposed on the propagation path of the blue light beam, and the wavelength conversion wheel 400 to make the segment 430 (see FIG. 3) of the wavelength conversion wheel 400 disposed on a path 224. The blue light beam emitted from the light source 100 passes through the lens 810 and propagates to the rotational wheel 200 along the path 102. After being reflected to the optical module 504 by the reflective segment 210 of the rotational wheel 200, the blue light beam is then guided to the desired position 900 along a path 214 by the optical module 504. The blue light beam propagates to the reflective mirror 524 first, being reflected by the reflective mirror 524, passing through the lens 544 and second dichroic mirror 534 in sequence, and propagating to the desired position 900.

In the second time period, the actuator 300 simultaneously rotates the rotational wheel 200 to make the transmission segment 220 (see FIG. 2) of the rotational wheel 200 is disposed on the propagation path of the blue light beam, and the wavelength conversion wheel 400 to make the green conversion segment 410 (see FIG. 3) of the wavelength conversion wheel 400 is disposed on the path 224. The blue light beam emitted from the light source 100 passes through the lens 810 and propagates to the rotational wheel 200 along the path 102. After passing through the transmission segment 220 of the rotational wheel 200, along the path 224, the blue light beam is reflected by the first dichroic mirror 514. Subsequently, the blue light beam is converged by the lenses 820 and 830 and propagates to the green conversion segment 410 of the wavelength conversion wheel 400. The green conversion segment 410 converts the blue light beam into the green light beam, which is reflected back to the lenses 820 and 830. The green light beam is then converged by the lenses 820 and 830 and is guided to the desired position 900 along a path 404 by the optical module 504. The green light beam passes through the first dichroic mirror 514 first, propagates to the second dichroic mirror 534, and is then reflected to the desired position 900 by the second dichroic mirror 534.

In the third time period, the actuator 300 simultaneously rotates the rotational wheel 200 to make the transmission segment 220 (see FIG. 2) of the rotational wheel 200 disposed on the propagation path of the blue light beam, and the wavelength conversion wheel 400 to make the red conversion segment 420 (see FIG. 3) of the wavelength conversion wheel 400 disposed on the path 224. The blue light beam emitted from the light source 100 passes through the lens 810 and propagates to the rotational wheel 200 along the path 102. After passing through the transmission segment 220 of the rotational wheel 200, the blue light beam propagates to the red conversion segment 420 of the wavelength conversion wheel 400 along the path 224. The red conversion segment 420 converts the blue light beam into the red light beam, which is reflected back to the lenses 820 and 830. The red light beam is then converged by the lenses 820 and 830 and is guided to the desired position 900 along the path 404 by the optical module 504. The red light beam passes through the first dichroic mirror 514 first, propagates to the second dichroic mirror 534, and is then reflected to the desired position 900 by the second dichroic mirror 534. Consequently, the display illuminating module can generate the blue light beam, the green light beam, and the red light beam in sequence as long as the actuator 300 rotates the rotational wheel 200 and the wavelength conversion wheel 400 in sequence using the method mentioned above. Other relevant structural details of the present embodiment are all the same as the embodiment shown in FIG. 1A and FIG. 1B, and, therefore, a description in this regard will not be repeated hereinafter.

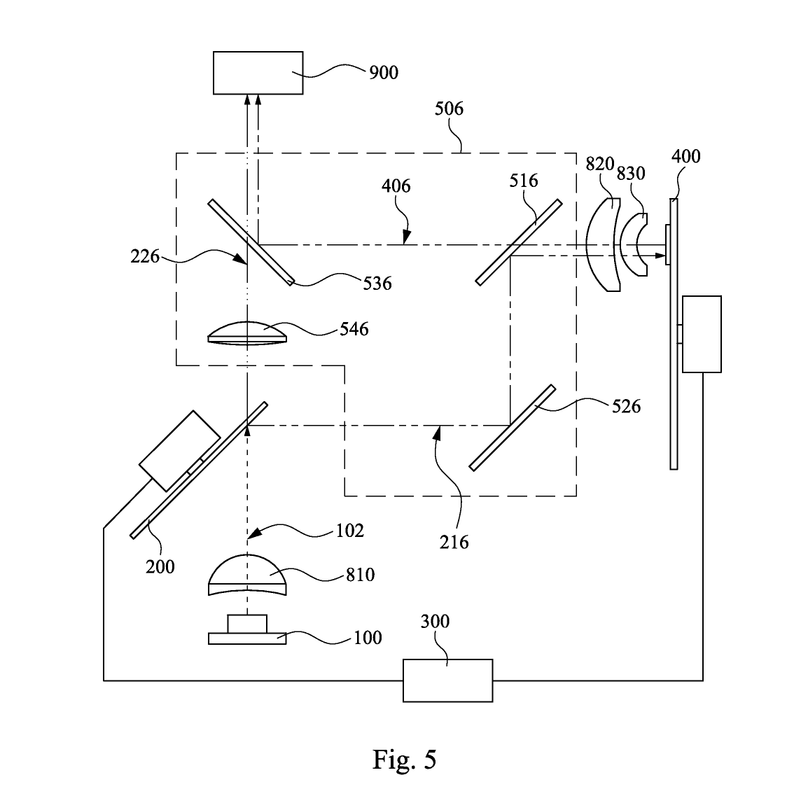

FIG. 5 is a schematic diagram of the display illuminating module according to yet another embodiment of the present invention. The difference between the display illuminating module of the present embodiment and the embodiment of FIG. 1A and FIG. 1B pertains to the elements of the optical module. In this embodiment, the optical module 506 includes a reflective mirror 526, a first dichroic mirror 516, and a second dichroic mirror 536. The reflective mirror 526 is configured for reflecting the blue light beam reflected from the rotational wheel 200 to the first dichroic mirror 516. The first dichroic mirror 516 allows the green light beam and the red light beam to pass therethrough, and is configured for reflecting the blue light beam propagating from the reflective mirror 526 to the wavelength conversion wheel 400. The second dichroic mirror 536 allows the blue light beam to pass therethrough, and is configured for reflecting the green light beam and the red light beam to the desired position 900. The optical module 506 can further include a lens 546 disposed between the rotational wheel 200 and the second dichroic mirror 536.

In the first time period, the actuator 300 simultaneously rotates the rotational wheel 200 to make the transmission segment 220 (see FIG. 2) of the rotational wheel 200 disposed on the propagation path of the blue light beam, and the wavelength conversion wheel 400 to make the segment 430 (see FIG. 3) of the wavelength conversion wheel 400 disposed on a path 216. The blue light beam emitted from the light source 100 passes through the lens 810 and propagates to the rotational wheel 200 along the path 102. After passing through the transmission segment 220 of the rotational wheel 200, the blue light beam is incident to the optical module 506, being guided to the desired position 900 along the path 226 by the optical module 506. The blue light beam passes through the lens 546 to the second dichroic mirror 536, and then passes through the second dichroic mirror 536 to the desired position 900.

In the second time period, the actuator 300 simultaneously rotates the rotational wheel 200 to make the reflective segment 210 (see FIG. 2) of the rotational wheel 200 disposed on the propagation path of the blue light beam, and the wavelength conversion wheel 400 to make the green conversion segment 410 (see FIG. 3) of the wavelength conversion wheel 400 disposed on the path 216 both by the actuator 300. The blue light beam emitted from the light source 100 passes through the lens 810 and propagates to the rotational wheel 200 along the path 102. After being reflected by the reflective segment 210 of the rotational wheel 200, the blue light beam is reflected to the first dichroic mirror 516 along the path 216 by the reflective mirror 526. The blue light beam is then reflected by the first dichroic mirror 516, is converged by the lenses 820 and 830, and propagates to the green conversion segment 410 of the wavelength conversion wheel 400. The green conversion segment 410 converts the blue light beam into the green light beam, which is reflected back to the lenses 820 and 830. The green light beam is then converged by the lenses 820 and 830 and is guided to the desired position 900 along a path 406 by the optical module 506. The green light beam passes through the first dichroic mirror 516 first, propagates to the second dichroic mirror 536, and is then reflected to the desired position 900 by the second dichroic mirror 536.

In the third time period, the actuator 300 simultaneously rotates the rotational wheel 200 to make the reflective segment 210 (see FIG. 2) of the rotational wheel 200 disposed on the propagation path of the blue light beam, and the wavelength conversion wheel 400 to make the red conversion segment 420 (see FIG. 3) of the wavelength conversion wheel 400 disposed on the path 216. The blue light beam emitted from the light source 100 passes through the lens 810 and propagates to the rotational wheel 200 along the path 102. After being reflected by the reflective segment 210 of the rotational wheel 200, the blue light beam is reflected to the red conversion segment 420 of the wavelength conversion wheel 400 along the path 216. The red conversion segment 420 converts the blue light beam into the red light beam, which is reflected back to the lenses 820 and 830. The red light beam is then converged by the lenses 820 and 830 and is guided to the desired position 900 along the path 406 by the optical module 506. The red light beam passes through the first dichroic mirror 516 first, propagates to the second dichroic mirror 536, and is then reflected to the desired position 900 by the second dichroic mirror 536. Consequently, the display illuminating module can generate the blue light beam, the green light beam, and the red light beam in sequence as long as the actuator 300 rotates the rotational wheel 200 and the wavelength conversion wheel 400 in sequence using the method mentioned above. Other relevant structural details of the present embodiment are all the same as the embodiment shown in FIG. 1A and FIG. 1B, and, therefore, a description in this regard will not be repeated hereinafter.

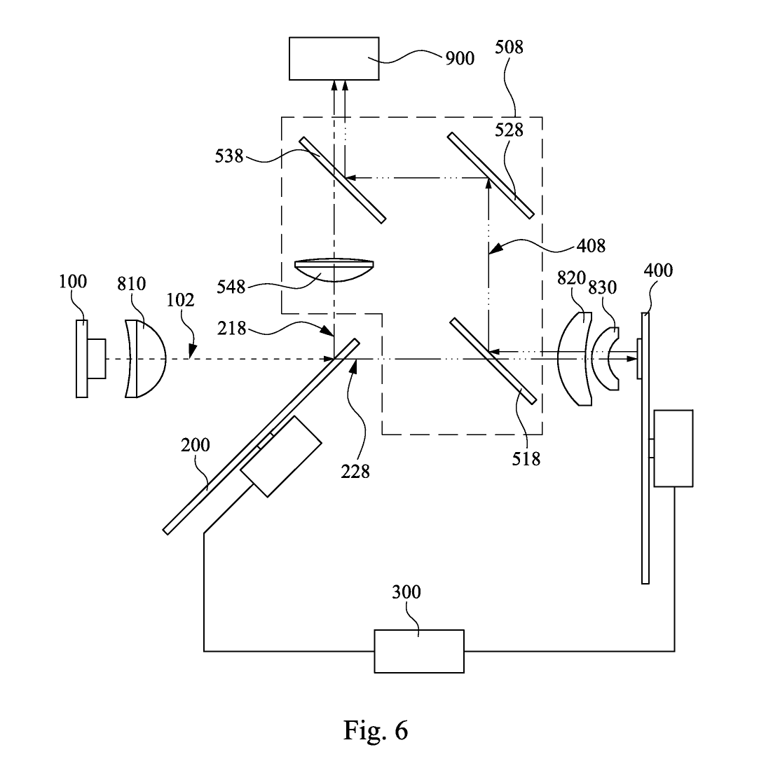

FIG. 6 is a schematic diagram of the display illuminating module according to yet another embodiment of the present invention. The difference between the display illuminating module of the present embodiment and the embodiment of FIG. 1A and FIG. 1B pertains to the elements of the optical module. In this embodiment, the optical module 508 includes a first dichroic mirror 518, a reflective mirror 528, and a second dichroic mirror 538. The first dichroic mirror 518 allows the blue light beam to pass therethrough, and is configured for reflecting the green light beam and the red light beam to the reflective mirror 528. The reflective mirror 528 is configured for reflecting the green light beam and the red light beam propagating from the first dichroic mirror 518 to the second dichroic mirror 538. The second dichroic mirror 538 allows the blue light beam to pass therethrough, and is configured for reflecting the green light beam and the red light beam to the desired position 900. Moreover, the optical module 508 can further include a lens 548 disposed between the rotational wheel 200 and the second dichroic mirror 538.

In the first time period, the actuator 300 simultaneously rotates the rotational wheel 200 to make the reflective segment 210 (see FIG. 2) of the rotational wheel 200 disposed on the propagation path of the blue light beam, and the wavelength conversion wheel 400 to make the segment 430 (see FIG. 3) of the wavelength conversion wheel 400 disposed on a path 228. The blue light beam emitted from the light source 100 passes through the lens 810 and propagates to the rotational wheel 200 along the path 102. After being reflected to the optical module 508 by the reflective segment 210 of the rotational wheel 200, the blue light beam is then guided to the desired position 900 along a path 218 by the optical module 508. The blue light beam passes through the lens 548 to the second dichroic mirror 538, and then passes through the second dichroic mirror 538 to the desired position 900.

In the second time period, the actuator 300 simultaneously rotates the rotational wheel 200 to make the transmission segment 220 (see FIG. 2) of the rotational wheel 200 disposed on the propagation path of the blue light beam, and the wavelength conversion wheel 400 to make the green conversion segment 410 (see FIG. 3) of the wavelength conversion wheel 400 disposed on the path 228. The blue light beam emitted from the light source 100 passes through the lens 810 and propagates to the rotational wheel 200 along the path 102. After passing through the transmission segment 220 of the rotational wheel 200, along the path 228, the blue light beam passes through the first dichroic mirror 518. Subsequently, the blue light beam is converged by the lenses 820 and 830 and propagates to the green conversion segment 410 of the wavelength conversion wheel 400. The green conversion segment 410 converts the blue light beam into the green light beam, which is reflected back to the lenses 820 and 830. The green light beam is then converged by the lenses 820 and 830 and is guided to the desired position 900 along a path 408 by the optical module 508. The green light beam is reflected to the reflective mirror 528 by the first dichroic mirror 518, being reflected to the second dichroic mirror 538 by the reflective mirror 528, and being reflected to the desired position 900 by the second dichroic mirror 538.

In the third time period, the actuator 300 simultaneously rotates the rotational wheel 200 to make the transmission segment 220 (see FIG. 2) of the rotational wheel 200 disposed on the propagation path of the blue light beam, and the wavelength conversion wheel 400 to make the red conversion segment 420 (see FIG. 3) of the wavelength conversion wheel 400 disposed on the path 228. The blue light beam emitted from the light source 100 passes through the lens 810 and propagates to the rotational wheel 200 along the path 102. After passing through the transmission segment 220 of the rotational wheel 200, the blue light beam propagates to the red conversion segment 420 of the wavelength conversion wheel 400 along the path 228. The red conversion segment 420 converts the blue light beam into the red light beam, which is reflected back to the lenses 820 and 830. The red light beam is then converged by the lenses 820 and 830 and is guided to the desired position 900 along the path 408 by the optical module 508. The red light beam is reflected to the reflective mirror 528 by the first dichroic mirror 518, being reflected to the second dichroic mirror 538 by the reflective mirror 528, and being reflected to the desired position 900 by the second dichroic mirror 538. Consequently, the display illuminating module can generate the blue light beam, the green light beam, and the red light beam in sequence as long as the actuator 300 rotates the rotational wheel 200 and the wavelength conversion wheel 400 in sequence using the method mentioned above. Other relevant structural details of the present embodiment are all the same as the embodiment shown in FIG. 1A and FIG. 1B, and, therefore, a description in this regard will not be repeated hereinafter.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A display illuminating module, comprising:
a light source for providing a first light beam with a first wavelength;
a rotational wheel comprising a transmission segment and a reflective segment;
an actuator connected to the rotational wheel and for rotating the rotational wheel to dispose the transmission segment and the reflective segment on a propagation path of the first light beam in sequence;
a wavelength conversion wheel comprising a first wavelength conversion segment for converting the first light beam into a second light beam with a second wavelength; and
an optical module for guiding the first light beam transmitted from the transmission segment of the rotational wheel to the wavelength conversion wheel, guiding the first light beam reflected from the reflective segment of the rotational wheel to a desired position, and guiding the second light beam propagating from the first wavelength conversion segment of the wavelength conversion wheel to the desired position.

2. The display illuminating module of claim 1, wherein the wavelength conversion wheel further comprises a second wavelength conversion segment for converting the first light beam into a third light beam with a third wavelength;
the actuator is further connected to the wavelength conversion wheel, and the actuator is further for rotating the wavelength conversion wheel to dispose the first wavelength conversion segment and the second wavelength conversion segment on the propagation path of the first light beam passing through the rotational wheel in sequence; and
the optical module is further for guiding the third light beam propagating from the second wavelength conversion segment of the wavelength conversion wheel to the desired position.

3. The display illuminating module of claim 2, wherein the first wavelength conversion segment and the second wavelength conversion segment are arc-shaped, and an arc length of the first wavelength conversion segment is different from an arc length of the second wavelength conversion segment.

4. The display illuminating module of claim 1, wherein the reflective segment and the transmission segment of the rotational wheel are arc-shaped, and an arc length of the reflective segment is different from an arc length of the transmission segment.

5. The display illuminating module of claim 1, wherein the optical module comprises a first dichroic mirror, a reflective mirror, and a second dichroic mirror, the first dichroic mirror allows the first light beam to pass therethrough and is for reflecting the second light beam to the second dichroic mirror, the reflective mirror is for reflecting the first light beam reflected from the rotational wheel to the second dichroic mirror, and the second dichroic mirror allows the second light beam to pass therethrough and is for reflecting the first light beam propagating from the reflective mirror to the desired position.

6. The display illuminating module of claim 1, wherein the optical module comprises a first dichroic mirror, a reflective mirror, and a second dichroic mirror, the first dichroic mirror allows the second light beam to pass therethrough and is for reflecting the first light beam propagating from the rotational wheel to the wavelength conversion wheel, the reflective mirror is for reflecting the first light beam reflected from the rotational wheel to the second dichroic mirror, and the second dichroic mirror allows the first light beam to pass therethrough and is for reflecting the second light beam to the desired position.

7. The display illuminating module of claim 1, wherein the optical module comprises a reflective mirror, a first dichroic mirror, and a second dichroic mirror, the reflective mirror is for reflecting the first light beam reflected from the rotational wheel to the first dichroic mirror, the first dichroic mirror allows the second light beam to pass therethrough and is for reflecting the first light beam propagating from the reflective mirror to the wavelength conversion wheel, and the second dichroic mirror allows the first light beam to pass therethrough and is for reflecting the second light beam to the desired position.

8. The display illuminating module of claim 1, wherein the optical module comprises a first dichroic mirror, a reflective mirror, and a second dichroic mirror, the first dichroic mirror allows the first light beam to pass therethrough and is for reflecting the second light beam to the reflective mirror, the reflective mirror is for reflecting the second light beam propagating from the first dichroic mirror to the second dichroic mirror, and the second dichroic mirror allows the first light beam to pass therethrough and is for reflecting the second light beam to the desired position.

9. The display illuminating module of claim 1, further comprising a plurality of lenses respectively disposed between the light source and the rotational wheel, between the optical module and the wavelength conversion wheel, and on the propagation path of the first light beam passing through the rotational wheel.
